(19) United States
(12) Patent Application Publication
(10) Pub. No.: US 2026/0113536 A1
(43) Pub. Date: Apr. 23, 2026

(54) SMART SENSOR MODE ACTIVATION

(71) Applicant: Comcast Cable Communications, LLC, Philadelphia, PA (US)

(72) Inventor: Christopher Stone, Philadelphia, PA (US)

(21) Appl. No.: 18/924,798

(22) Filed: Oct. 23, 2024

(51) Int. Cl. H04N 23/667; G06T 7/50; H04N 23/71

(52) U.S. Cl. CPC H04N 23/667; G06T 7/50; H04N 23/71; G06T 2207/10028; G06T 2207/30232

(57) ABSTRACT

One or more light sources in image data captured by a device (camera, sensor, etc.) may be analyzed, for example, using computational logic. A determination may be made as to whether the one or more light sources are sufficient for the device to monitor an area of interest or if the device should activate an IR mode. Activating an IR mode may comprise engaging one or more IR emitter, activating an IR mode (or night mode) associated with an image sensor, activating an IR mode (or night mode) associated with an image sensor processor, etc.

### BACKGROUND

A camera, such as a security camera used for surveillance of a premises, may use an infrared (IR) mode to “see” at night. The camera may have an ambient light sensor for measuring an amount of light (luminance) that the camera is sensing. When the luminance sensed falls below a pre-defined value, the camera may activate an IR mode. In such a system, a light in the distance may cause the luminance sensed by the camera to remain above the pre-defined value, even though the light in the distance is not illuminating an area of interest for the camera.

### SUMMARY

The systems and methods of the present disclosure relate to intelligent image capture. One or more light sources in image data captured by a device (camera, sensor, etc.) may be analyzed, for example, using computational logic. A determination may be made as to whether the one or more light sources are sufficient for the device to monitor an area of interest or if the device should activate an IR mode. Activating an IR mode may comprise engaging one or more IR emitter, activating an IR mode (or night mode) associated with an image sensor, activating an IR mode (or night mode) associated with an image sensor processor, etc.

### BRIEF DESCRIPTION OF THE DRAWINGS

FIG. 1 shows an environment in which the systems and methods described herein may operate.

FIG. 2 shows example image data according to the systems and methods described herein.

FIG. 3 shows example image data according to the systems and methods described herein.

FIG. 4 shows example image data according to the systems and methods described herein.

FIG. 5A shows example image data according to the systems and methods described herein.

FIG. 5B shows example image data according to the systems and methods described herein.

FIG. 6A shows example image data according to the systems and methods described herein.

FIG. 6B shows example image data according to the systems and methods described herein.

FIG. 6C shows example image data according to the systems and methods described herein.

FIG. 7A shows example image data according to the systems and methods described herein.

FIG. 7B shows example image data according to the systems and methods described herein.

FIG. 7C shows example image data according to the systems and methods described herein.

FIG. 8 shows example image data according to the systems and methods described herein.

FIG. 9 shows an example method for determining a sensor mode according to the systems and methods described herein.

FIG. 10 shows an example method for determining a sensor mode according to the systems and methods described herein.

FIG. 11 shows an example method for determining a sensor mode according to the systems and methods described herein.

FIG. 12 shows an example method for determining a sensor mode according to the systems and methods described herein.

FIG. 13 shows an example method for determining a sensor mode according to the systems and methods described herein.

### DETAILED DESCRIPTION

The systems and methods of the present disclosure relate to intelligent image capture. A camera, such as a security camera used for surveillance, may be caused to enter and/or exit an infrared (IR) mode or night node. For example, if a user has a camera to monitor people and/or objects near a front door on a porch, light from a street light 50 feet away may not help cast light on people and/or objects near the front door; however, such light from the street light could prevent the camera from entering an IR mode and better monitoring people and/or objects near the front door.

One or more light sources in image data captured by a device (camera, sensor, etc.) may be analyzed using, for example, computational logic. A determination may be made as to whether the one or more light sources are sufficient for the device to monitor an area of interest or if the device should activate an IR mode. Activating an IR mode may comprise engaging one or more IR emitter, activating an IR mode (or night mode) associated with an image sensor, activating an IR mode (or night mode) associated with an image sensor processor, etc.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

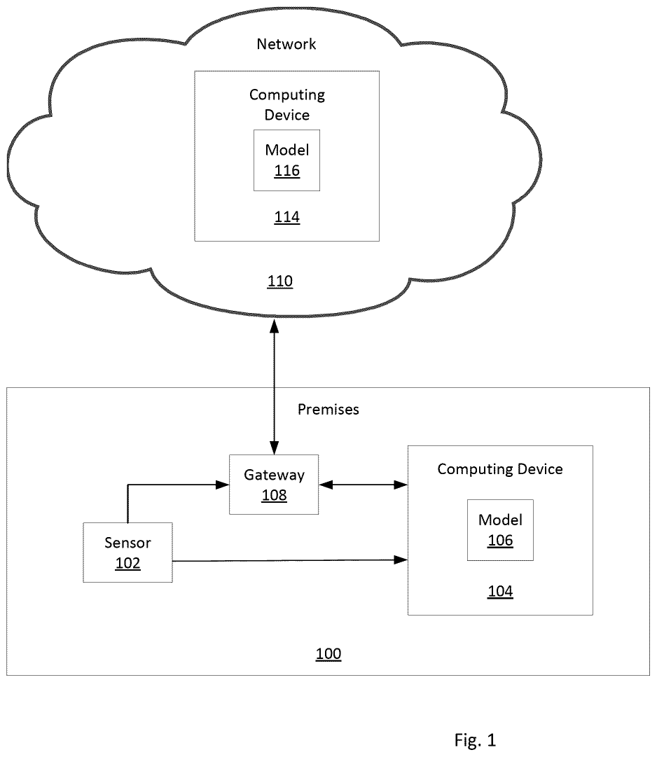

FIG. 1 shows an environment in which the systems and methods described herein may operate. The environment may comprise a premises 100 and a network 110. The premises may comprise a sensor 102, a local computing device 104, and a gateway 108. The local computing device 104 may comprise a model 106. The network 110 may comprise and/or be in communication with a remote computing device 114. The remote computing device 114 may comprise a model 116.

The premises 100 may comprise at least one of any area and/or structure over which surveillance is performed, a residential area and/or structure, a commercial area and/or structure, or an industrial area and/or structure. The premises 100 may be associated with a subscriber of a service, such as a security service.

The sensor 102 may capture image data. The sensor 102 may capture video data. The sensor 102 may capture audio data. The sensor 102 may be a component of an object, such as a camera. The sensor 102 may comprise a variety of modes, such as regular mode, IR (night) mode, etc. The sensor 102 may be used to monitor the premises 100. The sensor 102 may be associated with the subscriber of the service. The sensor 102 may be associated with a provider of the service. The sensor 102 may comprise an ambient light sensor. The sensor 102 may comprise an RGB (red, green, blue) image sensor. The sensor 102 may comprise a complex integrated circuit (IC).

The local computing device 104 may be coupled with the sensor 102 in an object, such as a camera, etc. The local computing device 104 may be coupled with the gateway 108. The local computing device 104 may be independent of the sensor 102 and the gateway 108. The local computing device 104 may be associated with the subscriber of the service. The local computing device 104 may be associated with the provider of the service.

The local computing device 104 may comprise a model 106. The model 106 may be trained to identify artifacts. The model 106 may be trained to identify features of artifacts. The model 106 may be trained to identify light sources. The model 106 may be trained to identify light sources on artifacts and/or features on artifacts. The model 106 may be trained to estimate distances of artifacts and/or features of artifacts from a sensor. The model 106 may be trained on a luminance threshold. The model 106 may be pre-trained prior to deployment. The model 106 may be trained with the sensor 102 at the premises 100. The model 106 may receive images at various hours to learn where various artifacts and/or light sources are in an area of interest at the premises 100. The model 106 may receive daytime image data, where a rocking chair on a porch in an area of interest is visible. The model 106 may receive nighttime image data, where the rocking chair in the area of interest becomes less visible as there is less light from the sun. The model 106 may associate a visibility of the rocking chair with a luminance threshold and use a visibility of the rocking chair in future image data to determine a luminance threshold. The model 106 may receive daytime image data, where a porchlight in an area of interest is visible. The model 106 may identify the porchlight as a light source. The model 106 may receive nighttime image data, where the porchlight is emitting light. The model 106 may determine a luminance value associated with the porchlight.

The gateway 108 may provide access to the network 110 to the premises 100. The gateway 108 may comprise a modem. The gateway 108 may facilitate communication between the sensor 102 and/or the local computing device 104 and the provider of the service. The gateway 108 may be associated with the subscriber of the service. The gateway 108 may be associated with the provider of the service.

The network 110 may comprise at least one of a public network, such as the Internet, a private network, a local area network, or a wide area network. The network 110 may be associated with the provider of the service. The network 110 may comprise and/or be in communication with the remote computing device 114. The network 110 may facilitate communication between the sensor 102 and/or the local computing device 104 and the remote computing device 114.

The remote computing device 114 may comprise one or more computing devices, such as servers. The remote computing device 114 may comprise a cloud computing environment. The remote computing device 114 may be associated with the provider of the service. The remote computing device 114 may not be present in some embodiments, where functions of the remote computing device 114 may be executed by the local computing device 104.

The remote computing device 114 may comprise a model 116. The model 116 may be trained to identify artifacts. The model 116 may be trained to identify features of artifacts. The model 116 may be trained to identify light sources. The model 116 may be trained to identify light sources on artifacts and/or features on artifacts. The model 116 may be trained to estimate distances of artifacts and/or features of artifacts from a sensor. The model 116 may be trained on a luminance threshold. The model 116 may be pre-trained prior to deployment. The model 116 may be trained with the sensor 102 at the premises 100. The model 116 may receive images at various hours to learn where various artifacts and/or light sources are in an area of interest at the premises 100. The model 116 may receive daytime image data, where a rocking chair on a porch in an area of interest is visible. The model 116 may receive nighttime image data, where the rocking chair in the area of interest becomes less visible as there is less light from the sun. The model 116 may associate a visibility of the rocking chair with a luminance threshold and use a visibility of the rocking chair in future image data to determine a luminance threshold. The model 116 may receive daytime image data, where a porchlight in an area of interest is visible. The model 116 may identify the porchlight as a light source. The model 116 may receive nighttime image data, where the porchlight is emitting light. The model 116 may determine a luminance value associated with the porchlight. Some embodiments may comprise the model 106 associated with the local computing device 104, some embodiments may comprise the model 116 associated with the remote computing device 114, and some embodiments may comprise both the model 106 associated with the local computing device 104 and the model 116 associated with the remote computing device 114.

The sensor 102 may capture one or more first images at the premises 100. The local computing device 104 may receive first image data indicative of the one or more first images. Alternatively, the remote computing device 114 may receive first image data indicative of the one or more first images. The local computing device 104 may use the first image data to train the model 106 to determine at least luminance information. Alternatively, the remote computing device 114 may use the first image data to train the model 116 to determine at least luminance information. The sensor 102 may capture one or more second images of the premises 100. The local computing device 104 may receive second image data indicative of the one or more second images. Alternatively, the remote computing device 114 may receive second image data indicative of the one or more second images. The local computing device 104 may receive an indication about luminance information of the second image data based on the model 106 and the second image data. Alternatively, the remote computing device 114 may receive an indication about luminance information of the second image data based on the model 116 and the second image data. The local computing device 104 may determine whether a sensor mode threshold has been satisfied based at least on the luminance information of the second image data. Alternatively, the remote computing device 114 may determine whether a sensor mode threshold has been satisfied based at least on the luminance information of the second image data. The local computing device 104 may cause transmission of a control signal to the sensor 102 based on the determining whether a sensor mode threshold has been satisfied. Alternatively, the remote computing device 114 may cause transmission of a control signal to the sensor 102 based on the determining whether a sensor mode threshold has been satisfied.

The local computing device 104 may receive image data from the sensor 102. Alternatively, the remote computing device 114 may receive image data from the sensor 102 via the network 110. The local computing device 104 may determine one or more light sources in the image data. Alternatively, the remote computing device 114 may determine one or more light sources in the image data. The local computing device 104 may determine one or more excluded light sources of the one or more light sources. Alternatively, the remote computing device 114 may determine one or more excluded light sources of the one or more light sources. Light sources in the image data not determined to be excluded light sources may be remaining light sources in the image data. The local computing device 104 may determine luminance information based on the remaining light sources in the image data. Alternatively, the remote computing device 114 may determine luminance information based on the remaining light sources in the image data. The local computing device 104 may determine whether a sensor mode threshold has been satisfied based on the luminance information. Alternatively, the remote computing device 114 may determine whether a sensor mode threshold has been satisfied based on the luminance information. The local computing device 104 may cause transmission of a control signal to the sensor 102 based on the determining whether a sensor mode threshold has been satisfied. Alternatively, the remote computing device 114 may cause transmission of a control signal to the sensor 102 based on the determining whether a sensor mode threshold has been satisfied.

The local computing device 104 may receive image data from the sensor 102. Alternatively, the remote computing device 114 may receive image data from the sensor 102 via the network 110. The local computing device 104 may determine one or more light sources in the image data. Alternatively, the remote computing device 114 may determine one or more light sources in the image data. The local computing device 104 may determine one or more excluded light sources of the one or more light sources. Alternatively, the remote computing device 114 may determine one or more excluded light sources of the one or more light sources. Light sources in the image data not determined to be excluded light sources may be remaining light sources in the image data. The local computing device 104 may determine luminance information based on the remaining light sources in the image data. Alternatively, the remote computing device 114 may determine luminance information based on the remaining light sources in the image data. The local computing device 104 may determine that a sensor mode threshold has not been satisfied based on the luminance information. Alternatively, the remote computing device 114 may determine that a sensor mode threshold has not been satisfied based on the luminance information. The local computing device 104 may cause transmission of a control signal to cause the sensor 102 to activate an infrared configuration based on the determining that the sensor mode threshold has not been satisfied. Alternatively, the remote computing device 114 may cause transmission of a control signal to cause the sensor 102 to activate an infrared configuration based on the determining that the sensor mode threshold has not been satisfied.

The local computing device 104 may receive image data from the sensor 102. Alternatively, the remote computing device 114 may receive image data from the sensor 102 via the network 110. The local computing device 104 may determine one or more light sources in the image data. Alternatively, the remote computing device 114 may determine one or more light sources in the image data. The local computing device 104 may determine one or more excluded light sources of the one or more light sources. Alternatively, the remote computing device 114 may determine one or more excluded light sources of the one or more light sources. Light sources in the image data not determined to be excluded light sources may be remaining light sources in the image data. The local computing device 104 may determine luminance information based on the remaining light sources in the image data. Alternatively, the remote computing device 114 may determine luminance information based on the remaining light sources in the image data. The local computing device 104 may determine that a sensor mode threshold has been satisfied based on the luminance information. Alternatively, the remote computing device 114 may determine that a sensor mode threshold has been satisfied based on the luminance information. The local computing device 104 may cause transmission of a control signal to cause the sensor 102 to activate a normal configuration based on the determining that the sensor mode threshold has been satisfied. Alternatively, the remote computing device 114 may cause transmission of a control signal to cause the sensor 102 to activate a normal configuration (e.g., visible light, non-infrared) based on the determining that the sensor mode threshold has been satisfied.

The model 106 and/or the model 116 may be trained to determine luminance information for an area of interest in an image captured by the sensor 102. The sensor 102 may capture an image of a front door of the premises 100. The image may comprise one or more light sources, such as a street light and a porch light. The area of interest in the image may comprise an area just before the front door, three and half feet to seven feet above the ground. The model 106 and/or the model 116 may determine luminance information for the area of interest in the image based determining light emitting from the light sources.

The model 106 and/or the model 116 may be trained to determine artifacts and/or features on an artifact. The model 106 and/or the model 116 may identify a utility pole and a lamp extending from the utility pole. The model 106 and/or the model 116 may identify a light bulb associated with a porch light. The model 106 and/or the model 116 may identify the lamp and/or the light bulb as light sources. The model 106 and/or the model 116 may determine an expected luminance for the identified light sources. The expected luminance of a lamp associated with a utility pole and/or the light bulb used as the porch light may be known and/or known to be within a certain range.

The model 106 and/or the model 116 may be trained to determine a distance of artifacts and/or features of artifacts from the sensor 102. A distance of a telephone line to the ground may be standard and known. A distance of a lamp to a utility pole from which the lamp is coupled may be known. A circumference of a light bulb may be known. The model 106 and/or the model 116 may use known actual distances and/or sizes and distances and/or sizes within a captured image to estimate a distance of an artifact and/or feature of an artifact to the sensor 102.

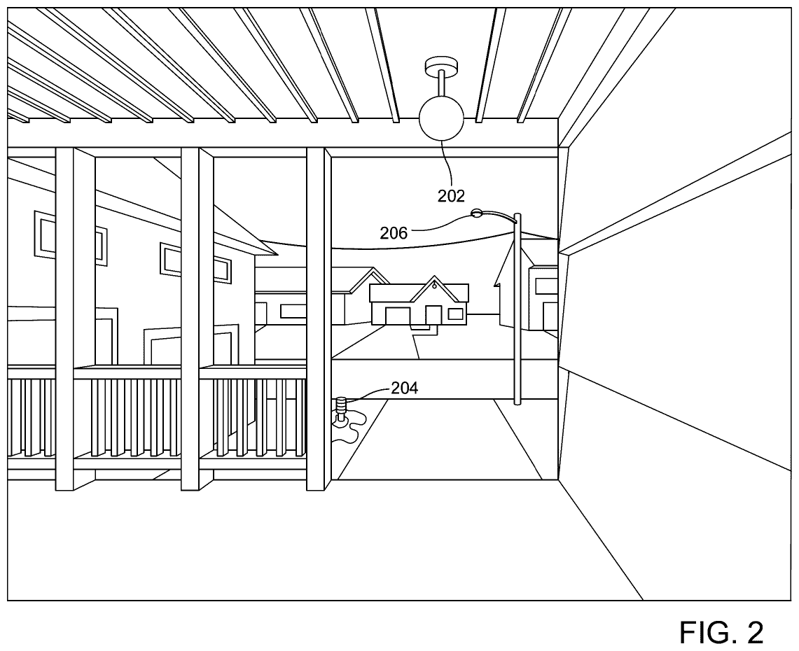

FIG. 2 shows example image data according to the systems and methods described herein. The image data may show image data captured from a sensor at a premises during daytime. The image data may be given to a model. The model may use the image data to identify artifacts and/or features of artifacts within the image data. The model may associate the identified artifacts and/or features of artifacts with locations within images of image data received from the sensor at the premises. The model may learn that image data from the sensor at the premises may have a porch light 202 at the top center. The model may learn that image data from the sensor at the premises may have a path light 204 near the center of the image. The model may learn that image data from the sensor at the premises may have a streetlight 206 at the top left. The model may also learn various other artifacts should be in image data received from the sensor at the premises, such as, a porch railing at the center left.

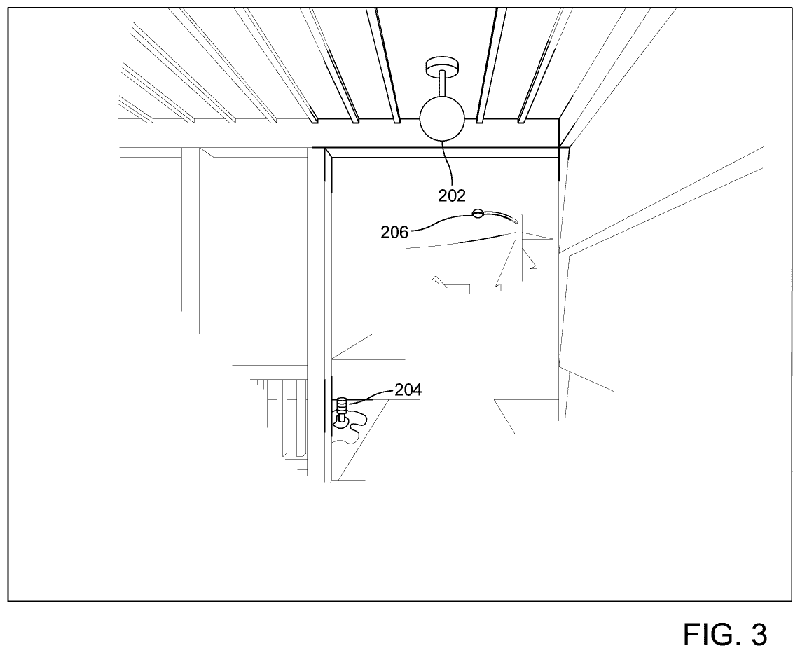

FIG. 3 shows example image data according to the systems and methods described herein. The image data shown in FIG. 3 may be captured by the same sensor that captured the image data in FIG. 2. The image data may show image data captured from the sensor at the premises during nighttime. As shown, light sources, such as the porch light 202, the path light 204, and the streetlight 206 may be illuminated. Various artifacts and/or features of artifacts visible in FIG. 2 may be visible in FIG. 3. Other artifacts and/or features of artifacts visible in FIG. 2 may be less visible in FIG. 3. Still other artifacts and/or features of artifacts visible in FIG. 2 may not be visible in FIG. 3.

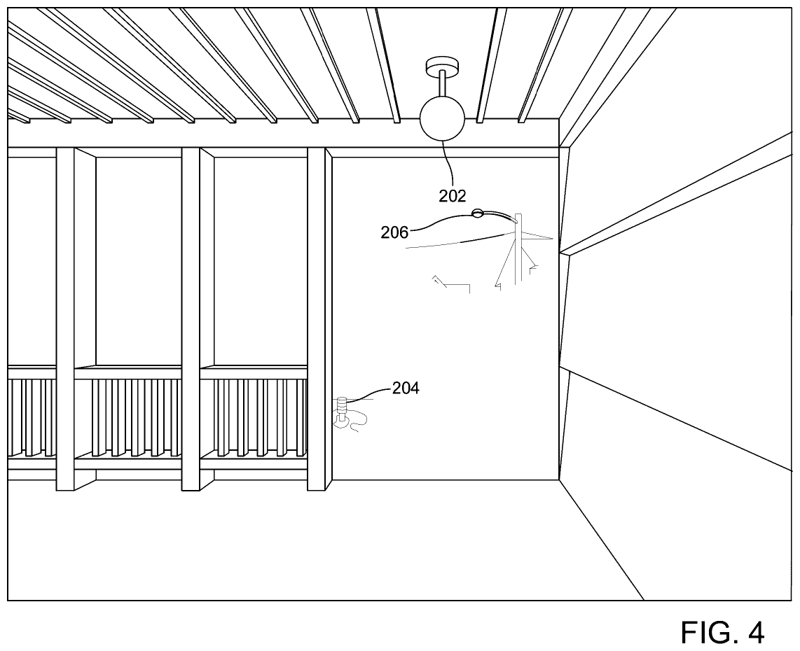

FIG. 4 shows example image data according to the systems and methods described herein. The image data shown in FIG. 4 may be captured by the same sensor that captured the image data in FIGS. 2-3. The image data may show image data captured from the sensor at the premises during nighttime and in infrared (IR) mode. As shown, artifacts and/or features of artifacts close to the sensor are shown in detail, but artifacts and/or features of artifacts in the background are lost. When the IR mode is active, one or more IR emitter may engage. When the IR mode is active, an IR mode (or night mode) associated with the sensor may activate. When the IR mode is active, an IR mode (or night mode) associated with a processor associated with the sensor may activate.

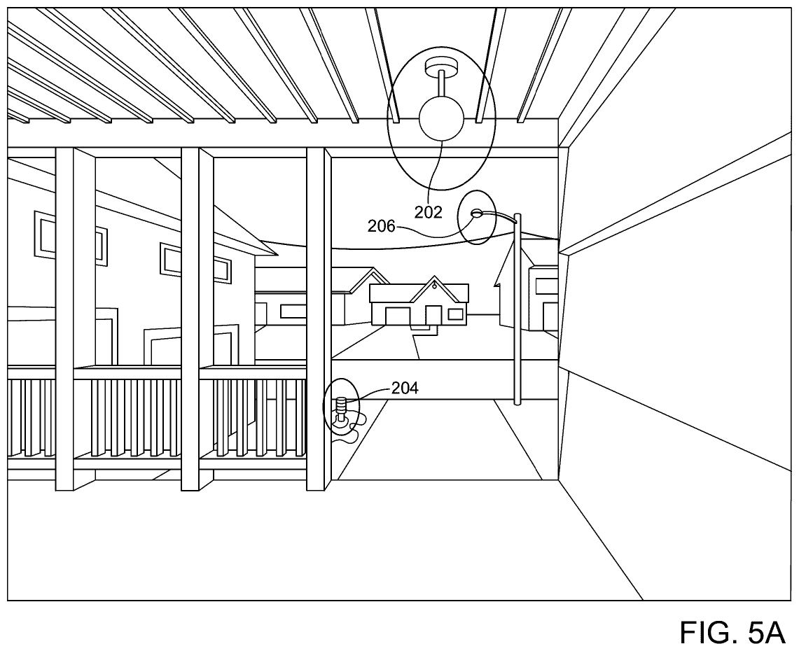

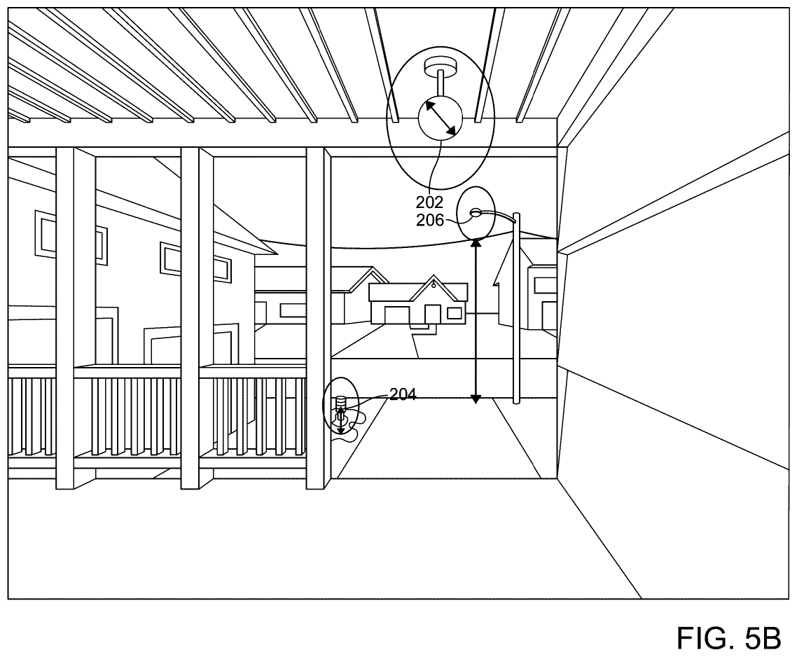

FIGS. 5A-5B show example image data according to the systems and methods described herein. The image data shown in FIGS. 5A-5B may be captured by the same sensor that captured the image data in FIGS. 2-4. A model may identify light sources in the image data. The model may identify the porch light 202, the path light 204, and the streetlight 206 as light sources. The model may associate a distance to the sensor for each identified light source. The model may use the circumference of the porch light 202 in the image data to estimate a distance from the porch light 202 to the sensor. The model may use the distance from the path light 204 to the ground to estimate the distance from the path light 204 to the sensor. The model may use a distance of a telephone line to the ground, a distance of the lamp of the streetlight to the utility pole, and/or a circumference of the lamp to estimate a distance of the lamp of the streetlight to the sensor. The model may use known information associated the identified light sources (such as watts, luminance, etc.) and/or distances from the sensor associated with the identified light sources to determine a luminance value associated with each of the identified light sources.

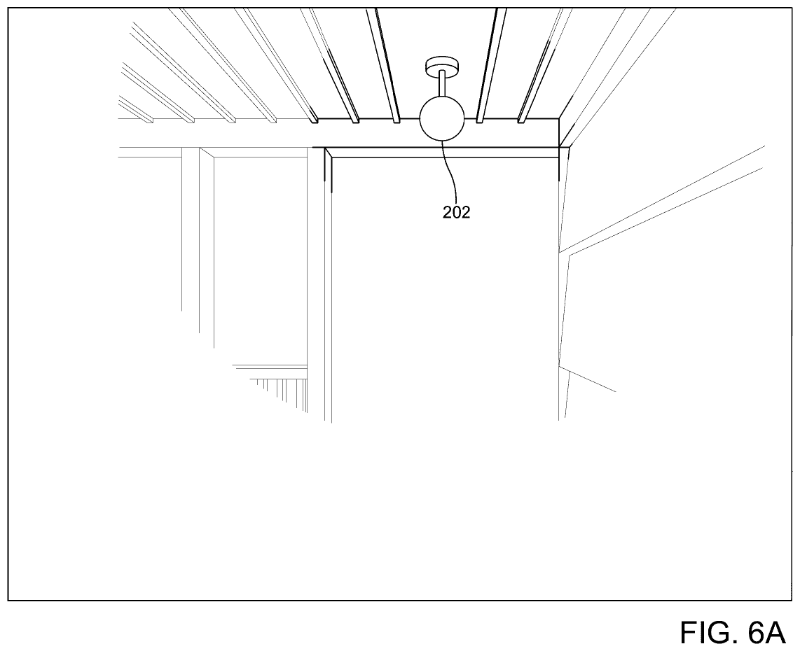

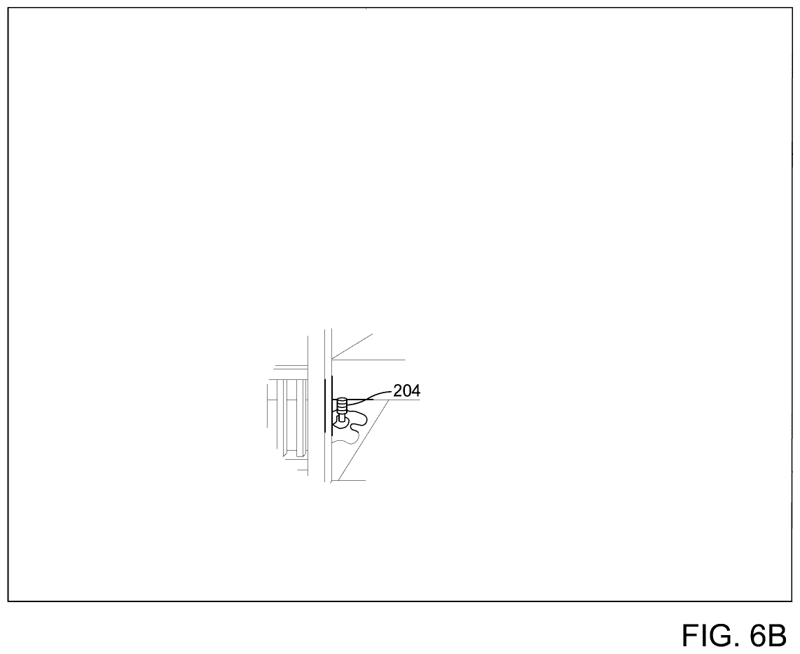

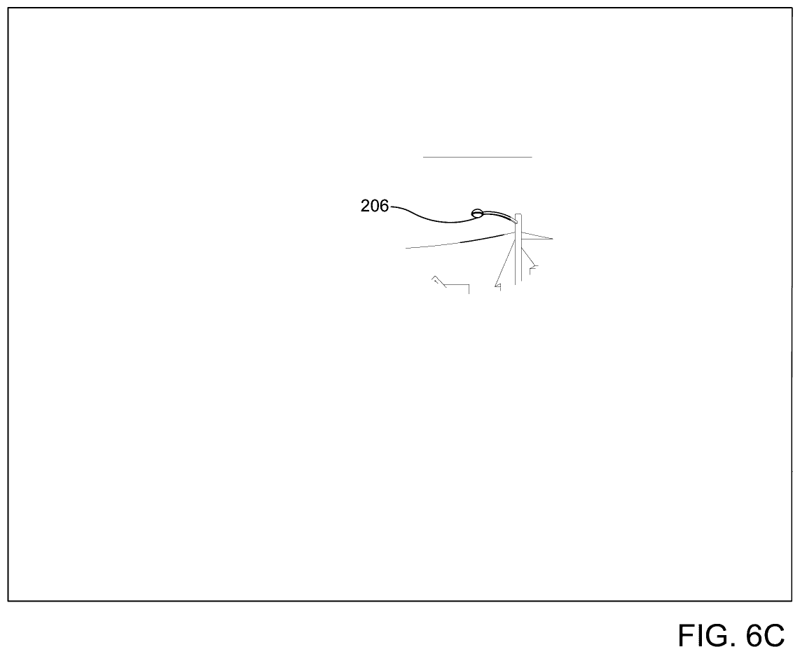

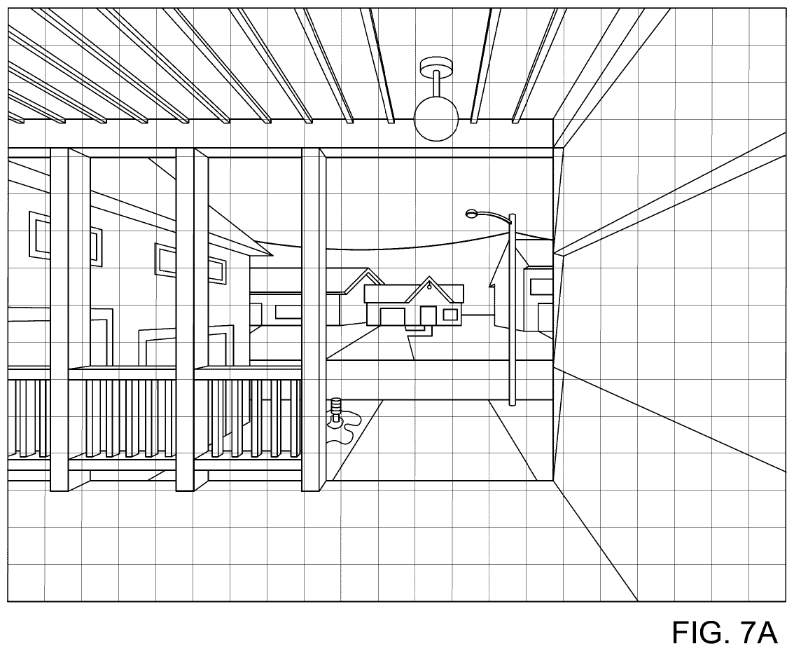

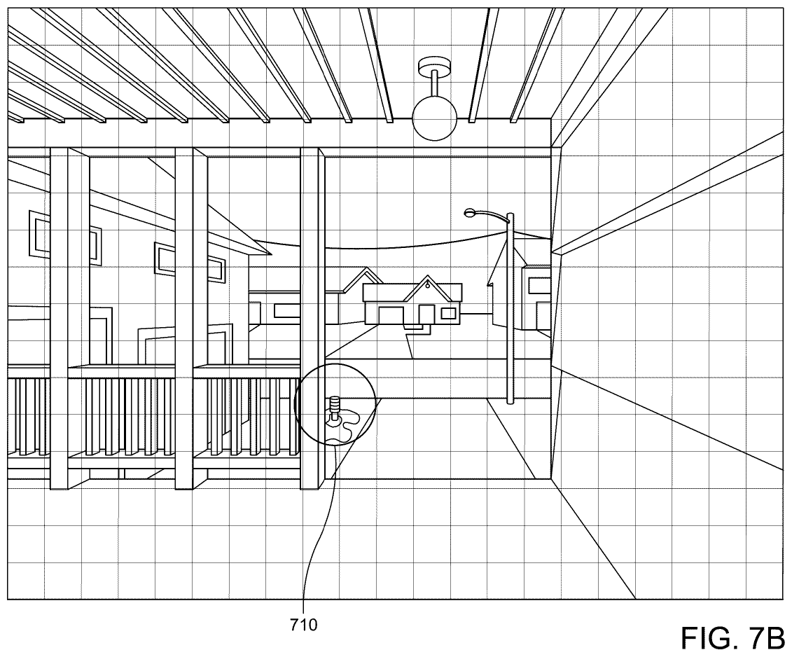

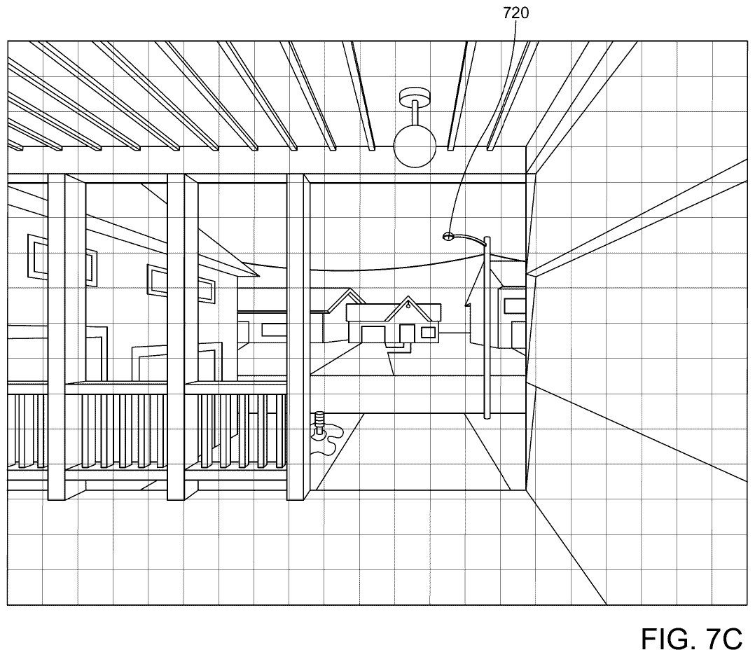

FIGS. 6A-6C and 7A-7C show example image data according to the systems and methods described herein. The image data shown in FIGS. 6A-6C and 7A-7C may be captured by the same sensor that captured the image data in FIG. 2-5B. FIG. 6A may show an area of image data illuminated by the porch light 202, and FIG. 7A may show a corresponding zone of luminance within the image data. FIG. 6B may show an area of image data illuminated by the path light 204, and FIG. 7B may show a corresponding zone of luminance 710 within the image data. FIG. 6C may show an area of image data illuminated by the streetlight 206, and FIG. 7C may show a corresponding zone of luminance 720 within the image data. When an area of interest in image data is illuminated by a light source, a determination of if the light source is emitting light may be used to decide which mode the sensor should have active. When the porch, in front of the sensor, is the area of interest, if the porch light 202 is on, a determination may be made to not activate IR mode associated with the sensor. When the area of interest is a car parked under the streetlight, if the streetlight 206 is not on, a determination may be made to activate IR mode associated with the sensor. When the model considers a luminance for a light source, the model may restrict the light source to its corresponding zone of luminance. If the area of interest for image data is in the porch, the zone of luminance 710 associated with the path light 204 and the zone of luminance 720 the streetlight 206 may restrict them from consideration, and the model may consider the luminance associated with the porch light 202.

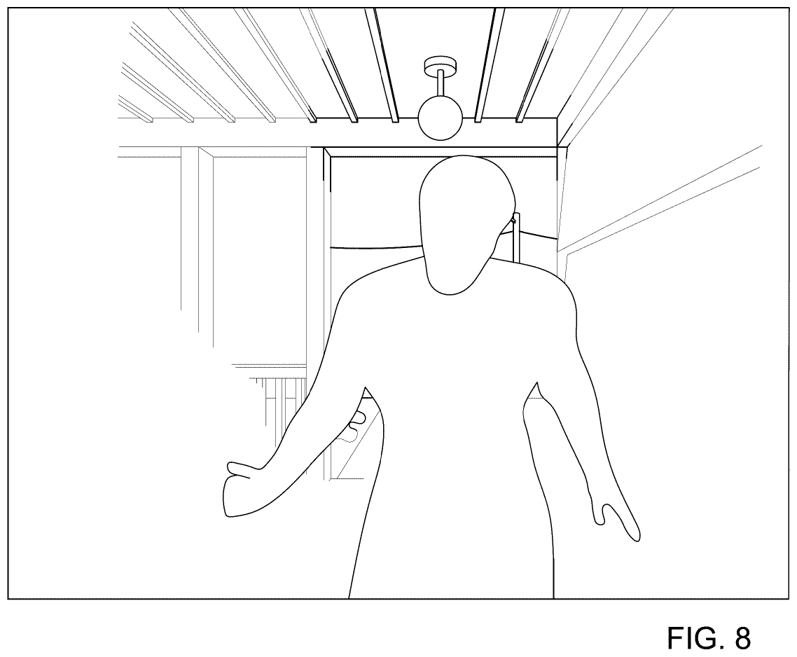

FIG. 8 shows example image data according to the systems and methods described herein. The image data shown in FIG. 8 may be captured by the same sensor that captured the image data in FIG. 2-7C. The image data may comprise a foreign entity. The model may recognize that the foreign entity is not typically in image data captured by the sensor at the premises. The model may recognize the foreign entity as a person. A luminance threshold, which determines when the IR mode of the sensor activates, may be a lower threshold. The threshold may be a point below which provided light is too low to provide details of artifacts, features of artifacts, and/or foreign entities in image data. A luminance threshold may be an upper threshold. The threshold may be a point above which indicates a likelihood of a foreign entity holding a flashlight to the sensor to avoid detection. Based on determining that a foreign entity is detected, determining that the upper threshold is satisfied, etc., a determination may be made of if sufficient details are captured in image data. If a determination is made that sufficient details are not being captured, then the sensor may be caused to toggle modes, either into or out of an IR mode. If a determination is made that sufficient details are not being captured, then the sensor may be caused to toggle between modes at an interval. The sensor may capture image data in IR mode for three seconds, switch to normal mode (e.g., non-infrared, visible light mode) and capture image data for three seconds, switch back to IR mode and capture image data for three seconds, and so on.

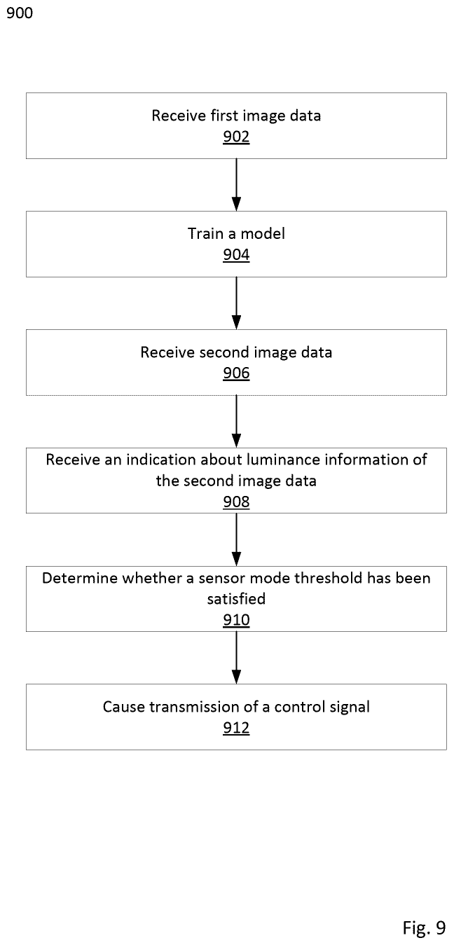

FIG. 9 is a flowchart of an example process 900. In some implementations, one or more process blocks of FIG. 9 may be performed by the local computing device 104 in FIG. 1 and/or the remote computing device 114 in FIG. 1.

First image data may be received (block 902). The local computing device 104 may receive first image data. The remote computing device 114 may receive first image data. The first image data may be indicative of one or more first images captured by at least one first sensor. The one or more first images may comprise video. The at least one first sensor may be associated with a camera. The at least one first sensor may comprise an infrared (IR) mode. The first image data may be captured at one or more first premises.

A model may be trained (block 904). The local computing device 104 may train a model. The remote computing device 114 may train a model. The model may be trained based at least on the first image data. The model may be trained to determine at least luminance information. Training the model may comprise providing to the model a first dataset. The first dataset may comprise a plurality of images of the one or more first premises in which a first artifact is visible. The first dataset may comprise an indication of sufficient luminance. Training the model may comprise providing to the model a second dataset. The second dataset may comprise a plurality of images of the one or more first premises in which the first artifact is not visible. The second dataset may comprise an indication of insufficient luminance.

Training the model may comprise providing to the model a first dataset. The first dataset may comprise a plurality of images satisfying a luminance threshold. The first dataset may comprise an indication of sufficient luminance. Training the model may comprise providing to the model a second dataset. The second dataset may comprise a plurality of images below the luminance threshold. The second dataset may comprise an indication of insufficient luminance.

Training the model may comprise at least one of training the model to recognize an artifact in an image, training the model to estimate a distance of the artifact to a sensor, training the model to recognize a feature of an artifact in an image, training the model to estimate a distance of the feature to a sensor, training the model to recognize an artifact in an image, training the model to estimate a distance of the light source to a sensor, training the model to recognize a light source in an image, or training the model to estimate a distance of the light source to a sensor. The artifact may comprise a light source.

Second image data may be received (block 906). The image data may be received by a computing device. The local computing device 104 may receive second image data. The remote computing device 114 may receive second image data. The second image data may be indicative of one or more second images captured by at least one second sensor. The one or more second images may comprise video. The at least one second sensor may be associated with a camera. The at least one first sensor may comprise the at least one second sensor. The at least one second sensor may comprise an infrared (IR) mode. The second image data may be captured at one or more second premises. The first premises may comprise the second premises. The at least one first sensor may be the same as the at least one second sensor. The one or more first premises may be the same as the one or more second premises. The first image data may comprise images recorded at a plurality of times. The model may determine at least luminance information based at least in part on a determination of whether the luminance threshold is satisfied in second image data.

An indication about luminance information of the second image data may be received (block 908). The local computing device 104 may receive an indication about luminance information of the second image data. The remote computing device 114 may receive an indication about luminance information of the second image data. The luminance information of the second image data may be based at least on the model and the second image data. The model may determine at least luminance information based at least in part on visibility of the first artifact in the second image data.

A determination may be made of whether a sensor mode threshold has been satisfied (block 910). The local computing device 104 may determine whether a sensor mode threshold has been satisfied. The remote computing device 114 may determine whether a sensor mode threshold has been satisfied. The determining whether a sensor mode threshold has been satisfied may be based at least on the luminance information of the second image data. The determining whether a sensor mode threshold has been satisfied may comprise determining, based at least on the luminance information of the second image data, that the sensor mode threshold has not been satisfied. The determining may comprise determining, based at least on the luminance information of the second image data, that the sensor mode threshold has been satisfied.

A control signal may be caused to be transmitted (block 912). The local computing device 104 may cause transmission of a control signal. The remote computing device 114 may cause transmission of a control signal. The control signal may be caused to be transmitted to the at least one second sensor. The control signal may be caused to be transmitted based on the determining whether a sensor mode threshold has been satisfied. The causing transmission of a control signal may comprise causing transmission of a control signal configured to cause the at least one second sensor to activate an infrared configuration based on the determining that the sensor mode threshold has not been satisfied. The causing transmission of a control signal may comprise causing transmission of a control signal configured to cause the at least one second sensor to activate a normal configuration based on the determining that the sensor mode threshold has been satisfied.

A foreign entity may be determined to be present in the second image data. The local computing device 104 may determine a foreign entity is present in the second image data. The remote computing device 114 may determine a foreign entity is present in the second image data. The causing transmission of a control signal may further comprise causing transmission of a control signal configured to cause the at least one second sensor to oscillate between an infrared configuration and a normal configuration based on the determining a foreign entity is present in the second image data. The control signal may cause the at least one second sensor to oscillate between the infrared configuration and the normal configuration at regular intervals of time. The regular intervals of time may be, for example, 1 second, 2 seconds, 2.5 seconds, 3 seconds, etc.

Although example blocks are shown, some implementations may include additional blocks, fewer blocks, different blocks, or differently arranged blocks than those depicted. Additionally, or alternatively, two or more of the blocks may be performed in parallel.

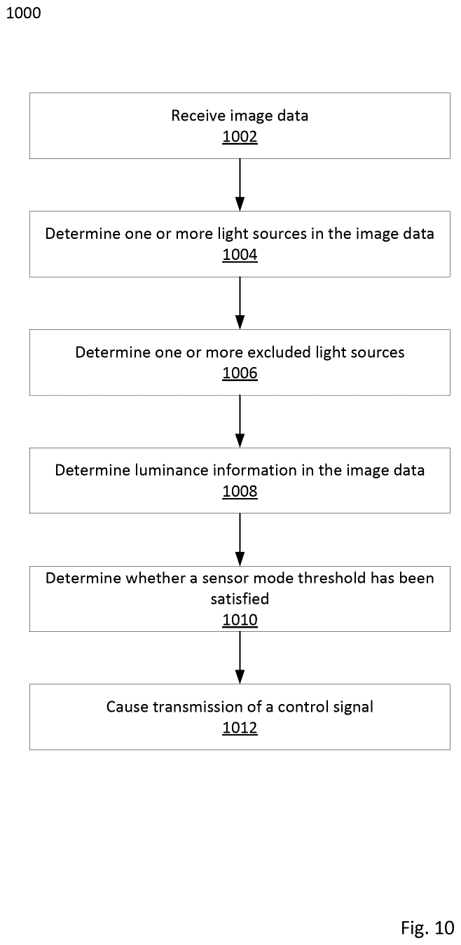

FIG. 10 is a flowchart of an example process 1000. In some implementations, one or more process blocks of FIG. 10 may be performed by the local computing device 104 in FIG. 1 and/or the remote computing device 114 in FIG. 1.

Image data may be received (block 1002). The local computing device 104 may receive image data. The remote computing device 114 may receive image data. The image data may be received from a sensor. The image data may be indicative of one or more images captured by the sensor. The one or more images may comprise video. The sensor may be associated with a camera. The sensor may comprise an infrared (IR) mode. The image data may be captured at a premises associated with the sensor.

One or more light sources in the image data may be determined (block 1004). The local computing device 104 may determine one or more light sources in the image data. The remote computing device 114 may determine one or more light sources in the image data. The determining one or more light sources in the image data may comprise determining one or more artifacts and/or features of an artifact in the image data. The determining one or more light sources in the image data may comprise determining emitted light in the image data.

One or more excluded light sources may be determined (block 1006). The local computing device 104 may determine one or more excluded light sources. The remote computing device 114 may determine one or more excluded light sources. The excluded light sources may be excluded from the one or more light sources determined at step 1004. Light sources in the image data not determined to be excluded light sources are remaining light sources in the image data. The determining one or more excluded light sources may further comprise estimating a distance from each light source to the sensor. The determining one or more excluded light sources may further comprise estimating a brightness associated with each light source. The determining one or more excluded light sources may further comprise ignoring one or more portions of image data associated with the one or more excluded light sources. The determining one or more excluded light sources may further comprise ignoring one or more portions of image data associated with the one or more excluded light sources.

Luminance information in the image data may be determined (block 1008). The local computing device 104 may determine luminance information in the image data. The remote computing device 114 may determine luminance information in the image data. The determining luminance information in the image data may be based on the remaining light sources in the image data. The determining luminance information in the image data may comprise at least one of making a determination of sufficient luminance based on an existence of at least one remaining light source in the image data, making a determination of insufficient luminance based on no remaining light source in the image data, identifying a recognized artifact or a feature of the recognized artifact in the image data, or identifying a recognized artifact or a feature of the recognized artifact in a portion of the image data that is not ignored.

A determination may be made of whether a sensor mode threshold has been satisfied (block 1010). The local computing device 104 may determine whether a sensor mode threshold has been satisfied. The remote computing device 114 may determine whether a sensor mode threshold has been satisfied. The determining whether a sensor mode threshold has been satisfied may be based on the luminance information. The determining whether a sensor mode threshold has been satisfied may comprise determining, based on the luminance information, that the sensor mode threshold has not been satisfied. The determining whether a sensor mode threshold has been satisfied may comprise determining, based on the luminance information, that the sensor mode threshold has been satisfied.

A control signal may be caused to be transmitted (block 1012). The local computing device 104 may cause transmission of a control signal to the sensor. The remote computing device 114 may cause transmission of a control signal to the sensor. The control signal may be caused to be transmitted to the sensor. The control signal may be caused to be transmitted based on the determining whether a sensor mode threshold has been satisfied. The causing transmission of a control signal may comprise causing transmission of a control signal configured to cause the sensor to activate an infrared configuration based on the determining that the sensor mode threshold has not been satisfied. The causing transmission of a control signal may comprise causing transmission of a control signal configured to cause the sensor to activate a normal configuration based on the determining that the sensor mode threshold has been satisfied.

A foreign entity may be determined to be present in the image data. The local computing device 104 may determine a foreign entity is present in the image data. The remote computing device 114 may determine a foreign entity is present in the image data. The causing transmission of a control signal may comprise causing transmission of a control signal configured to cause the sensor to oscillate between an infrared configuration and a normal configuration based on the determining a foreign entity is present in the second image data. The control signal may cause the sensor to oscillate between the infrared configuration and the normal configuration at regular intervals of time. The regular intervals of time may be, for example, 1 second, 2 seconds, 2.5 seconds, 3 seconds, etc.

Although example blocks are shown, some implementations may include additional blocks, fewer blocks, different blocks, or differently arranged blocks than those depicted. Additionally, or alternatively, two or more of the blocks may be performed in parallel.

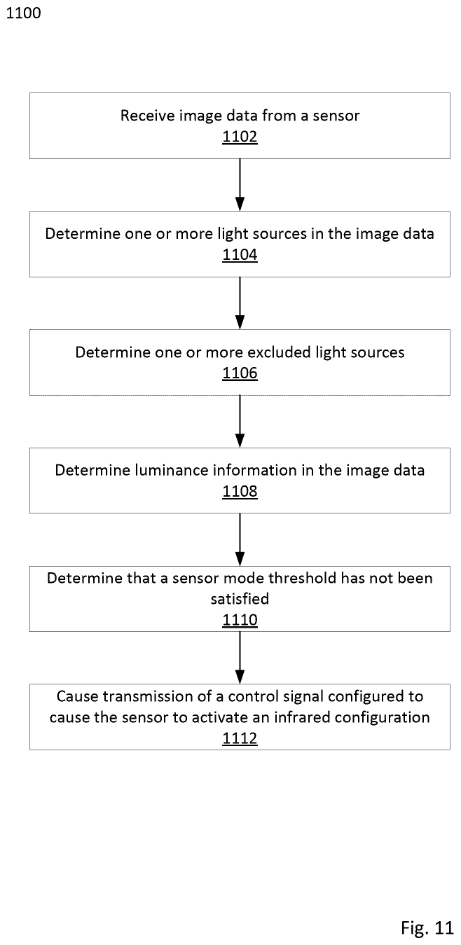

FIG. 11 is a flowchart of an example process 1100. In some implementations, one or more process blocks of FIG. 11 may be performed by the local computing device 104 in FIG. 1 and/or the remote computing device 114 in FIG. 1.

Image data may be received from a sensor (block 1102). The local computing device 104 may receive image data from a sensor. The remote computing device 114 may receive image data from a sensor. The image data may be indicative of one or more images captured by the sensor. The one or more images may comprise video. The sensor may be associated with a camera. The sensor may comprise an infrared (IR) mode. The image data may be captured at a premises associated with the sensor.

One or more light sources in the image data may be determined (block 1104). The local computing device 104 may determine one or more light sources in the image data. The remote computing device 114 may determine one or more light sources in the image data. The determining one or more light sources in the image data may comprise determining one or more artifacts and/or features of an artifact in the image data. The determining one or more light sources in the image data may comprise determining emitted light in the image data.

One or more excluded light sources may be determined (block 1106). The local computing device 104 may determine one or more excluded light sources. The remote computing device 114 may determine one or more excluded light sources. The excluded light sources may be excluded from the one or more light sources determined at step 1104. Light sources in the image data not determined to be excluded light sources are remaining light sources in the image data. The determining one or more excluded light sources may further comprise estimating a distance from each light source to the sensor. The determining one or more excluded light sources may further comprise estimating a brightness associated with each light source. The determining one or more excluded light sources may further comprise ignoring one or more portions of image data associated with the one or more excluded light sources. The determining one or more excluded light sources may further comprise ignoring one or more portions of image data associated with the one or more excluded light sources.

Luminance information in the image data may be determined (block 1108). The local computing device 104 may determine luminance information in the image data. The remote computing device 114 may determine luminance information in the image data. The determining luminance information in the image data may be based on the remaining light sources in the image data. The determining luminance information in the image data may comprise at least one of making a determination of sufficient luminance based on an existence of at least one remaining light source in the image data, making a determination of insufficient luminance based on no remaining light source in the image data, identifying a recognized artifact or a feature of the recognized artifact in the image data, or identifying a recognized artifact or a feature of the recognized artifact in a portion of the image data that is not ignored.

A determination may be made that a sensor mode threshold has not been satisfied (block 1110). The local computing device 104 may determine that a sensor mode threshold has not been satisfied. The remote computing device 114 may determine that a sensor mode threshold has not been satisfied. The determining that a sensor mode threshold has not been satisfied may be based on the luminance information.

A control signal configured to cause the sensor to activate an infrared configuration may be caused to be transmitted (block 1112). The local computing device 104 may cause transmission of a control signal configured to cause the sensor to activate an infrared configuration. The remote computing device 114 may cause transmission of a control signal configured to cause the sensor to activate an infrared configuration. The causing transmission of a control signal configured to cause the sensor to activate an infrared configuration may be based on the determining that the sensor mode threshold has not been satisfied.

Although example blocks are shown, some implementations may include additional blocks, fewer blocks, different blocks, or differently arranged blocks than those depicted. Additionally, or alternatively, two or more of the blocks may be performed in parallel.

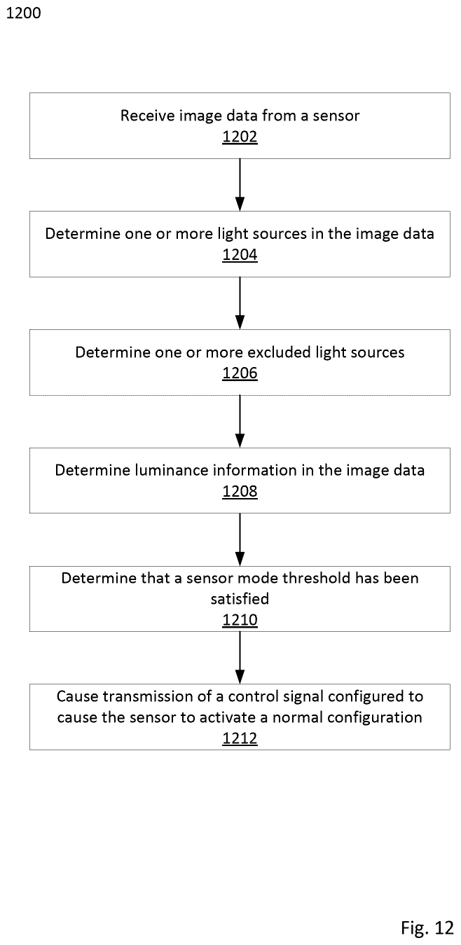

FIG. 12 is a flowchart of an example process 1200. In some implementations, one or more process blocks of FIG. 12 may be performed by the local computing device 104 in FIG. 1 and/or the remote computing device 114 in FIG. 1.

Image data may be received from a sensor (block 1202). The local computing device 104 may receive image data from a sensor. The remote computing device 114 may receive image data from a sensor. The image data may be indicative of one or more images captured by the sensor. The one or more images may comprise video. The sensor may be associated with a camera. The sensor may comprise an infrared (IR) mode. The image data may be captured at a premises associated with the sensor.

One or more light sources in the image data may be determined (block 1204). The local computing device 104 may determine one or more light sources in the image data. The remote computing device 114 may determine one or more light sources in the image data. The determining one or more light sources in the image data may comprise determining one or more artifacts and/or features of an artifact in the image data. The determining one or more light sources in the image data may comprise determining emitted light in the image data.

One or more excluded light sources may be determined (block 1206). The local computing device 104 may determine one or more excluded light sources. The remote computing device 114 may determine one or more excluded light sources. The excluded light sources may be excluded from the one or more light sources determined at step 1204. Light sources in the image data not determined to be excluded light sources are remaining light sources in the image data. The determining one or more excluded light sources may further comprise estimating a distance from each light source to the sensor. The determining one or more excluded light sources may further comprise estimating a brightness associated with each light source. The determining one or more excluded light sources may further comprise ignoring one or more portions of image data associated with the one or more excluded light sources. The determining one or more excluded light sources may further comprise ignoring one or more portions of image data associated with the one or more excluded light sources.

Luminance information in the image data may be determined (block 1208). The local computing device 104 may determine luminance information in the image data. The remote computing device 114 may determine luminance information in the image data. The determining luminance information in the image data may be based on the remaining light sources in the image data. The determining luminance information in the image data may comprise at least one of making a determination of sufficient luminance based on an existence of at least one remaining light source in the image data, making a determination of insufficient luminance based on no remaining light source in the image data, identifying a recognized artifact or a feature of the recognized artifact in the image data, or identifying a recognized artifact or a feature of the recognized artifact in a portion of the image data that is not ignored.

A determination may be made that a sensor mode threshold has been satisfied (block 1210). The local computing device 104 may determine that a sensor mode threshold has been satisfied. The remote computing device 114 may determine that a sensor mode threshold has been satisfied. The determining that a sensor mode threshold has been satisfied may be based on the luminance information.

A control signal configured to cause the sensor to activate a normal configuration may be caused to be transmitted (block 1212). The local computing device 104 may cause transmission of a control signal configured to cause the sensor to activate a normal configuration. The remote computing device 114 may cause transmission of a control signal configured to cause the sensor to activate a normal configuration. The causing transmission of a control signal configured to cause the sensor to activate a normal configuration may be based on the determining that the sensor mode threshold has been satisfied.

Although example blocks are shown, some implementations may include additional blocks, fewer blocks, different blocks, or differently arranged blocks than those depicted. Additionally, or alternatively, two or more of the blocks may be performed in parallel.

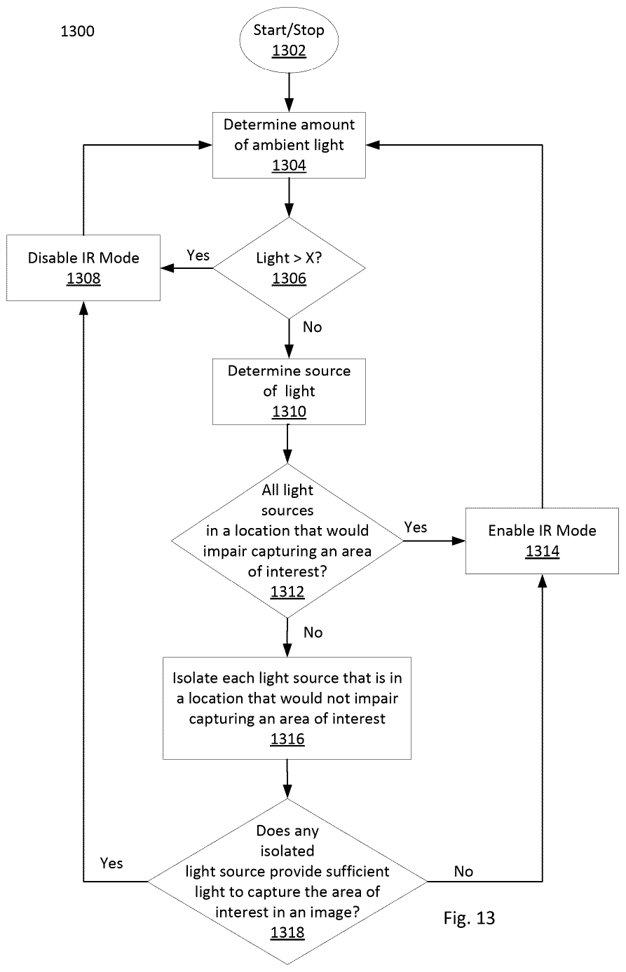

FIG. 13 shows an example method 1300 for determining a sensor mode according to the systems and methods described herein. At step 1302, the method 1300 may begin and/or end. At step 1302, image data associated with a device, such as a camera or sensor, may be received. At step 1304, an amount of ambient light in the image data may be determined. The sensor may comprise an ambient light sensor. The sensor may receive photons at a first time. The sensor may measure the photons received at the first time to determine an amount of ambient light at the first time. The amount of ambient light determined at the first time may be associated with image data captured at the first time. The sensor may comprise an RGB image sensor. The RGB image sensor may capture image data. An amount of ambient light in image data captured by the RGB image sensor may be determined by analyzing the image data. The sensor may comprise the ambient light sensor and the RGB image sensor. The sensor may use the ambient light sensor if a photon threshold is satisfied and the RGB image sensor if the photon threshold is not satisfied.

At step 1306, a determination may be made of if the determined amount of ambient light exceeds a predefined threshold. If a determination is made that the determined amount of ambient light exceeds the predefined threshold, then the method 1300 may advance to step 1308. If a determination is made that the determined amount of ambient light does not exceed the predefined threshold, then the method 1300 may advance to step 1310. At step 1308, an infrared (IR) mode associated with the device may be disabled, and the process 1300 may return to step 1304. At step 1310, one or more sources of light may be determined in the image data. At step 1312, a determination is made of if all of the sources of light determined at step 1310 are in a location that would impair capturing an image at an area of interest. If a determination is made that all of the sources of light determined at step 1310 are in a location that would impair capturing an image at an area of interest, then the process 1300 may advance to step 1314. If a determination is made that not all of the sources of light determined at step 1310 are in a location that would impair capturing an image at an area of interest, then the process 1300 may advance to step 1316. At step 1314, the IR mode associated with the device may be enabled, and the process 1300 may return to step 1304. At step 1316, each of the light sources determined to not be in a location that would impair capturing an image at an area of interest are isolated for analysis. At step 1318, a determination is made of if any of the light sources isolated in step 1316 provide sufficient light to capture the area of interest in an image. If a determination is made that at least one of the light sources isolated in step 1316 provide sufficient light to capture the area of interest in an image, then the process 1300 may advance to step 1308. If a determination is made that none of the light sources isolated in step 1316 provide sufficient light to capture the area of interest in an image, then the process 1300 may advance to step 1314.

### EXAMPLES

Example Clause 1: A method may include: receiving first image data indicative of one or more first images captured by at least one first sensor at one or more first premises; training, based at least on the first image data, a model to determine at least luminance information; receiving, by a computing device, second image data indicative of one or more second images captured by at least one second sensor at one or more second premises; receiving an indication about luminance information of the second image data, where the luminance information of the second image data is based at least on the model and the second image data; determining, based at least on the luminance information of the second image data, whether a sensor mode threshold has been satisfied; and causing transmission of a control signal to the at least one second sensor based on the determining whether a sensor mode threshold has been satisfied.

Example Clause 2: The method of Example Clause 1, where the at least one first sensor is the same as the at least one second sensor, where the one or more first premises is the same as the one or more second premises, and where the first image data may include images recorded at a plurality of times.

Example Clause 3: The method of Example Clause 1 or Example Clause 2, where the training a model to determine at least luminance information further may include: providing to the model a first dataset, where the first dataset may include a plurality of images of the one or more first premises in which a first artifact is visible, and where the first dataset may include an indication of sufficient luminance; and providing to the model a second dataset, where the second dataset may include a plurality of images of the one or more first premises in which the first artifact is not visible, and where the second dataset may include an indication of insufficient luminance.

Example Clause 4: The method of any one of Example Clauses 1-3, where the model determines at least luminance information based at least in part on visibility of the first artifact in the second image data.

Example Clause 5: The method of any one of Example Clauses 1-4, where the training a model to determine at least luminance information further may include: providing to the model a first dataset, where the first dataset may include a plurality of images satisfying a luminance threshold, and where the first dataset may include an indication of sufficient luminance; and providing to the model a second dataset, where the second dataset may include a plurality of images below the luminance threshold, and where the second dataset may include an indication of insufficient luminance.

Example Clause 6: The method of any one of Example Clauses 1-5, where the model determines at least luminance information based at least in part on a determination of whether the luminance threshold is satisfied in second image data.

Example Clause 7: The method of any one of Example Clauses 1-6, where the training a model to determine at least luminance information further may include training the model to recognize an artifact in an image.

Example Clause 8: The method of any one of Example Clauses 1-7, where the training a model to determine at least luminance information further may include training the model to estimate a distance of the artifact to a sensor.

Example Clause 9: The method of any one of Example Clauses 1-8, where the training a model to determine at least luminance information further may include training the model to recognize a feature of an artifact in an image.

Example Clause 10: The method of any one of Example Clauses 1-9, where the training a model to determine at least luminance information further may include training the model to estimate a distance of the feature to a sensor.

Example Clause 11: The method of any one of Example Clauses 1-10, where the training a model to determine at least luminance information further may include training the model to recognize an artifact in an image, where the artifact may include a light source.

Example Clause 12: The method of any one of Example Clauses 1-11, where the training a model to determine at least luminance information further may include training the model to estimate a distance of the light source to a sensor.

Example Clause 13: The method of any one of Example Clauses 1-12, where the training a model to determine at least luminance information further may include training the model to recognize a light source in an image.

Example Clause 14: The method of any one of Example Clauses 1-13, where the training a model to determine at least luminance information further may include training the model to estimate a distance of the light source to a sensor.

Example Clause 15: The method of any one of Example Clauses 1-14, further may include: where the determining, based at least on the luminance information of the second image data, whether a sensor mode threshold has been satisfied may include determining, based at least on the luminance information of the second image data, that the sensor mode threshold has not been satisfied; and where the causing transmission of a control signal to the at least one second sensor based on the determining whether a sensor mode threshold has been satisfied may include causing transmission of a control signal configured to cause the at least one second sensor to activate an infrared configuration based on the determining that the sensor mode threshold has not been satisfied.

Example Clause 16: The method of any one of Example Clauses 1-15, further may include: where the determining, based at least on the luminance information of the second image data, whether a sensor mode threshold has been satisfied may include determining, based at least on the luminance information of the second image data, that the sensor mode threshold has been satisfied; and where the causing transmission of a control signal to the at least one second sensor based on the determining whether a sensor mode threshold has been satisfied may include causing transmission of a control signal configured to cause the at least one second sensor to activate a normal configuration based on the determining that the sensor mode threshold has been satisfied.

Example Clause 17: The method of any one of Example Clauses 1-16, further may include determining a foreign entity is present in the second image data.

Example Clause 18: The method of any one of Example Clauses 1-17, where the causing transmission of a control signal to the at least one second sensor based on the determining whether a sensor mode threshold has been satisfied further may include causing transmission of a control signal configured to cause the at least one second sensor to oscillate between an infrared configuration and a normal configuration based on the determining a foreign entity is present in the second image data.

Example Clause 19: The method of any one of Example Clauses 1-18, where the control signal causes the at least one second sensor to oscillate between the infrared configuration and the normal configuration at regular intervals of time.

Example Clause 20: The method of any one of Example Clauses 1-19, where the regular intervals of time are 3 seconds.

Example Clause 21: A method may include: receiving image data from a sensor; determining one or more light sources in the image data; determining one or more excluded light sources of the one or more light sources, where light sources in the image data not determined to be excluded light sources are remaining light sources in the image data; determining luminance information based on the remaining light sources in the image data; determining, based on the luminance information, whether a sensor mode threshold has been satisfied; and causing transmission of a control signal to the sensor based on the determining whether a sensor mode threshold has been satisfied.

Example Clause 22: The method of Example Clause 21, where the determining one or more excluded light sources of the one or more light sources further may include estimating a distance from each light source to the sensor.

Example Clause 23: The method of Example Clause 21 or Example Clause 22, where the determining one or more excluded light sources of the one or more light sources further may include estimating a brightness associated with each light source.

Example Clause 24: The method of any one of Example Clauses 21-23, where the determining luminance information based on the remaining light sources in the image data may include making a determination of sufficient luminance based on an existence of at least one remaining light source in the image data.

Example Clause 25: The method of any one of Example Clauses 21-24, where the determining luminance information based on the remaining light sources in the image data may include making a determination of insufficient luminance based on no remaining light source in the image data.

Example Clause 26: The method of any one of Example Clauses 21-25, where the determining one or more excluded light sources of the one or more light sources further may include ignoring one or more portions of image data associated with the one or more excluded light sources.

Example Clause 27: The method of any one of Example Clauses 21-26, where the determining luminance information based on the remaining light sources in the image data may include identifying a recognized artifact or a feature of the recognized artifact in the image data.

Example Clause 28: The method of any one of Example Clauses 21-27, where the determining one or more excluded light sources of the one or more light sources further may include ignoring one or more portions of image data associated with the one or more excluded light sources.

Example Clause 29: The method of any one of Example Clauses 21-28, where the determining luminance information based on the remaining light sources in the image data may include identifying a recognized artifact or a feature of the recognized artifact in a portion of the image data that is not ignored.

Example Clause 30: The method of any one of Example Clauses 21-29, further may include: where the determining, based on the luminance information, whether a sensor mode threshold has been satisfied may include determining, based on the luminance information, that the sensor mode threshold has not been satisfied; and where the causing transmission of a control signal to the sensor based on the determining whether a sensor mode threshold has been satisfied may include causing transmission of a control signal configured to cause the sensor to activate an infrared configuration based on the determining that the sensor mode threshold has not been satisfied.

Example Clause 31: The method of any one of Example Clauses 21-30, further may include: where the determining, based on the luminance information, whether a sensor mode threshold has been satisfied may include determining, based on the luminance information, that the sensor mode threshold has been satisfied; and where the causing transmission of a control signal to the sensor based on the determining whether a sensor mode threshold has been satisfied may include causing transmission of a control signal configured to cause the sensor to activate a normal configuration based on the determining that the sensor mode threshold has been satisfied.

Example Clause 32: The method of any one of Example Clauses 21-31, further may include determining a foreign entity is present in the image data.

Example Clause 33: The method of any one of Example Clauses 21-32, where the causing transmission of a control signal to the sensor based on the determining whether a sensor mode threshold has been satisfied further may include causing transmission of a control signal configured to cause the sensor to oscillate between an infrared configuration and a normal configuration based on the determining a foreign entity is present in the second image data.

Example Clause 34: The method of any one of Example Clauses 21-33, where the control signal causes the sensor to oscillate between the infrared configuration and the normal configuration at regular intervals of time.

Example Clause 35: The method of any one of Example Clauses 21-34, where the regular intervals of time are 3 seconds.

Example Clause 36: A method may include: receiving image data from a sensor; determining one or more light sources in the image data; determining one or more excluded light sources of the one or more light sources, where light sources in the image data not determined to be excluded light sources are remaining light sources in the image data; determining luminance information based on the remaining light sources in the image data; determining, based on the luminance information, that a sensor mode threshold has not been satisfied; and causing transmission of a control signal configured to cause the sensor to activate an infrared configuration based on the determining that the sensor mode threshold has not been satisfied.

Example Clause 37: The method of Example Clause 36, where the determining one or more excluded light sources of the one or more light sources further may include estimating a distance from each light source to the sensor.

Example Clause 38: The method of Example Clause 36 or Example Clause 37, where the determining one or more excluded light sources of the one or more light sources further may include estimating a brightness associated with each light source.

Example Clause 39: The method of any one of Example Clauses 36-38, where the determining luminance information based on the remaining light sources in the image data may include making a determination of sufficient luminance based on an existence of at least one remaining light source in the image data.

Example Clause 40: The method of any one of Example Clauses 36-39, where the determining luminance information based on the remaining light sources in the image data may include making a determination of insufficient luminance based on no remaining light source in the image data.

Example Clause 41: The method of any one of Example Clauses 36-40, where the determining one or more excluded light sources of the one or more light sources further may include ignoring one or more portions of image data associated with the one or more excluded light sources.

Example Clause 42: The method of any one of Example Clauses 36-41, where the determining luminance information based on the remaining light sources in the image data may include identifying a recognized artifact or a feature of the recognized artifact in the image data.

Example Clause 43: The method of any one of Example Clauses 36-42, where the determining one or more excluded light sources of the one or more light sources further may include ignoring one or more portions of image data associated with the one or more excluded light sources.

Example Clause 44: The method of any one of Example Clauses 36-43, where the determining luminance information based on the remaining light sources in the image data may include identifying a recognized artifact or a feature of the recognized artifact in a portion of the image data that is not ignored.

Example Clause 45: A method may include: receiving image data from a sensor; determining one or more light sources in the image data; determining one or more excluded light sources of the one or more light sources, where light sources in the image data not determined to be excluded light sources are remaining light sources in the image data; determining luminance information based on the remaining light sources in the image data; determining, based on the luminance information, that a sensor mode threshold has been satisfied; and causing transmission of a control signal configured to cause the sensor to activate a normal configuration based on the determining that the sensor mode threshold has been satisfied.

Example Clause 46: The method of Example Clause 45, where the determining one or more excluded light sources of the one or more light sources further may include estimating a distance from each light source to the sensor.

Example Clause 47: The method of Example Clause 45 or Example Clause 46, where the determining one or more excluded light sources of the one or more light sources further may include estimating a brightness associated with each light source.

Example Clause 48: The method of any one of Example Clauses 45-47, where the determining luminance information based on the remaining light sources in the image data may include making a determination of sufficient luminance based on an existence of at least one remaining light source in the image data.

Example Clause 49: The method of any one of Example Clauses 45-48, where the determining luminance information based on the remaining light sources in the image data may include making a determination of insufficient luminance based on no remaining light source in the image data.

Example Clause 50: The method of any one of Example Clauses 45-49, where the determining one or more excluded light sources of the one or more light sources further may include ignoring one or more portions of image data associated with the one or more excluded light sources.

Example Clause 51: The method of any one of Example Clauses 45-50, where the determining luminance information based on the remaining light sources in the image data may include identifying a recognized artifact or a feature of the recognized artifact in the image data.

Example Clause 52: The method of any one of Example Clauses 45-51, where the determining one or more excluded light sources of the one or more light sources further may include ignoring one or more portions of image data associated with the one or more excluded light sources.

Example Clause 53: The method of any one of Example Clauses 45-52, where the determining luminance information based on the remaining light sources in the image data may include identifying a recognized artifact or a feature of the recognized artifact in a portion of the image data that is not ignored.

Example Clause 54: A system may include: one or more processors configured to: receive first image data indicative of one or more first images captured by at least one first sensor at one or more first premises; train, based at least on the first image data, a model to determine at least luminance information; receive second image data indicative of one or more second images captured by at least one second sensor at one or more second premises; receive an indication about luminance information of the second image data, where the luminance information of the second image data is based at least on the model and the second image data; determine, based at least on the luminance information of the second image data, whether a sensor mode threshold has been satisfied; and cause transmission of a control signal to the at least one second sensor based on the determining whether a sensor mode threshold has been satisfied.

Example Clause 55: The system of Example Clause 54, where the at least one first sensor is the same as the at least one second sensor, where the one or more first premises is the same as the one or more second premises, and where the first image data may include images recorded at a plurality of times.

Example Clause 56: The system of Example Clause 54 or Example Clause 55, where the one or more processors, when the training a model to determine at least luminance information, are configured to: provide to the model a first dataset, where the first dataset may include a plurality of images of the one or more first premises in which a first artifact is visible, and where the first dataset may include an indication of sufficient luminance; and provide to the model a second dataset, where the second dataset may include a plurality of images of the one or more first premises in which the first artifact is not visible, and where the second dataset may include an indication of insufficient luminance.

Example Clause 57: The system of any one of Example Clauses 54-56, where the model determines at least luminance information based at least in part on visibility of the first artifact in the second image data.

Example Clause 58: The system of any one of Example Clauses 54-57, where the one or more processors, when the training a model to determine at least luminance information, are configured to: provide to the model a first dataset, where the first dataset may include a plurality of images satisfying a luminance threshold, and where the first dataset may include an indication of sufficient luminance; and provide to the model a second dataset, where the second dataset may include a plurality of images below the luminance threshold, and where the second dataset may include an indication of insufficient luminance.

Example Clause 59: The system of any one of Example Clauses 54-58, where the model determines at least luminance information based at least in part on a determination of whether the luminance threshold is satisfied in second image data.

Example Clause 60: The system of any one of Example Clauses 54-59, where the one or more processors, when the training a model to determine at least luminance information, are configured to train the model to recognize an artifact in an image.

Example Clause 61: The system of any one of Example Clauses 54-60, where the one or more processors, when the training a model to determine at least luminance information, are configured to train the model to estimate a distance of the artifact to a sensor.

Example Clause 62: The system of any one of Example Clauses 54-61, where the one or more processors, when the training a model to determine at least luminance information, are configured to train the model to recognize a feature of an artifact in an image.

Example Clause 63: The system of any one of Example Clauses 54-62, where the one or more processors, when the training a model to determine at least luminance information, are configured to train the model to estimate a distance of the feature to a sensor.

Example Clause 64: The system of any one of Example Clauses 54-63, where the one or more processors, when the training a model to determine at least luminance information, are configured to train the model to recognize an artifact in an image, where the artifact may include a light source.

Example Clause 65: The system of any one of Example Clauses 54-64, where the one or more processors, when the training a model to determine at least luminance information, are configured to train the model to estimate a distance of the light source to a sensor.

Example Clause 66: The system of any one of Example Clauses 54-65, where the one or more processors, when the training a model to determine at least luminance information, are configured to train the model to recognize a light source in an image.

Example Clause 67: The system of any one of Example Clauses 54-66, where the one or more processors, when the training a model to determine at least luminance information, are configured to train the model to estimate a distance of the light source to a sensor.

Example Clause 68: The system of any one of Example Clauses 54-67, where the one or more processors, when the determining, based at least on the luminance information of the second image data, whether a sensor mode threshold has been satisfied, are configured to determine, based at least on the luminance information of the second image data, that the sensor mode threshold has not been satisfied; and where the one or more processors, when the causing transmission of a control signal to the at least one second sensor based on the determining whether a sensor mode threshold has been satisfied, are configured to cause transmission of a control signal configured to cause the at least one second sensor to activate an infrared configuration based on the determining that the sensor mode threshold has not been satisfied.

Example Clause 69: The system of any one of Example Clauses 54-68, where the one or more processors, when the determining, based at least on the luminance information of the second image data, whether a sensor mode threshold has been satisfied, are configured to determine, based at least on the luminance information of the second image data, that the sensor mode threshold has been satisfied; and where the one or more processors, when the causing transmission of a control signal to the at least one second sensor based on the determining whether a sensor mode threshold has been satisfied, are configured to cause transmission of a control signal configured to cause the at least one second sensor to activate a normal configuration based on the determining that the sensor mode threshold has been satisfied.

Example Clause 70: The system of any one of Example Clauses 54-69, where the one or more processors are further configured to: determine a foreign entity is present in the second image data.

Example Clause 71: The system of any one of Example Clauses 54-70, where the one or more processors, when the causing transmission of a control signal to the at least one second sensor based on the determining whether a sensor mode threshold has been satisfied, are configured to cause transmission of a control signal configured to cause the at least one second sensor to oscillate between an infrared configuration and a normal configuration based on the determining a foreign entity is present in the second image data.

Example Clause 72: The system of any one of Example Clauses 54-71, where the control signal causes the at least one second sensor to oscillate between the infrared configuration and the normal configuration at regular intervals of time.

Example Clause 73: The system of any one of Example Clauses 54-72, where the regular intervals of time are 3 seconds.

Example Clause 74: A system may include: one or more processors configured to: receive image data from a sensor; determine one or more light sources in the image data; determine one or more excluded light sources of the one or more light sources, where light sources in the image data not determined to be excluded light sources are remaining light sources in the image data; determine luminance information based on the remaining light sources in the image data; determine, based on the luminance information, whether a sensor mode threshold has been satisfied; and cause transmission of a control signal to the sensor based on the determining whether a sensor mode threshold has been satisfied.

Example Clause 75: The system of Example Clause 74, where the one or more processors, when the determining one or more excluded light sources of the one or more light sources, are configured to estimate a distance from each light source to the sensor.

Example Clause 76: The system of Example Clause 74 or Example Clause 75, where the one or more processors, when the determining one or more excluded light sources of the one or more light sources, are configured to estimate a brightness associated with each light source.

Example Clause 77: The system of any one of Example Clauses 74-76, where the one or more processors, when the determining luminance information based on the remaining light sources in the image data, are configured to make a determination of sufficient luminance based on an existence of at least one remaining light source in the image data.

Example Clause 78: The system of any one of Example Clauses 74-77, where the one or more processors, when the determining luminance information based on the remaining light sources in the image data, are configured to make a determination of insufficient luminance based on no remaining light source in the image data.

Example Clause 79: The system of any one of Example Clauses 74-78, where the one or more processors, when the determining one or more excluded light sources of the one or more light sources, are configured to ignore one or more portions of image data associated with the one or more excluded light sources.

Example Clause 80: The system of any one of Example Clauses 74-79, where the one or more processors, when the determining luminance information based on the remaining light sources in the image data, are configured to identify a recognized artifact or a feature of the recognized artifact in the image data.

Example Clause 81: The system of any one of Example Clauses 74-80, where the one or more processors, when the determining one or more excluded light sources of the one or more light sources, are configured to ignore one or more portions of image data associated with the one or more excluded light sources.

Example Clause 82: The system of any one of Example Clauses 74-81, where the one or more processors, when the determining luminance information based on the remaining light sources in the image data, are configured to identify a recognized artifact or a feature of the recognized artifact in a portion of the image data that is not ignored.

Example Clause 83: The system of any one of Example Clauses 74-82, where the one or more processors, when the determining, based on the luminance information, whether a sensor mode threshold has been satisfied, are configured to determine, based on the luminance information, that the sensor mode threshold has not been satisfied; and where the one or more processors, when the causing transmission of a control signal to the sensor based on the determining whether a sensor mode threshold has been satisfied, are configured to cause transmission of a control signal configured to cause the sensor to activate an infrared configuration based on the determining that the sensor mode threshold has not been satisfied.

Example Clause 84: The system of any one of Example Clauses 74-83, where the one or more processors, when the determining, based on the luminance information, whether a sensor mode threshold has been satisfied are configured to determine, based on the luminance information, that the sensor mode threshold has been satisfied; and where the one or more processors, when the causing transmission of a control signal to the sensor based on the determining whether a sensor mode threshold has been satisfied, are configured to cause transmission of a control signal configured to cause the sensor to activate a normal configuration based on the determining that the sensor mode threshold has been satisfied.

Example Clause 85: The system of any one of Example Clauses 74-84, where the one or more processors are further configured to: determine a foreign entity is present in the image data.

Example Clause 86: The system of any one of Example Clauses 74-85, where the one or more processors, when the causing transmission of a control signal to the sensor based on the determining whether a sensor mode threshold has been satisfied, are configured to cause transmission of a control signal configured to cause the sensor to oscillate between an infrared configuration and a normal configuration based on the determining a foreign entity is present in the second image data.

Example Clause 87: The system of any one of Example Clauses 74-86, where the control signal causes the sensor to oscillate between the infrared configuration and the normal configuration at regular intervals of time.

Example Clause 88: The system of any one of Example Clauses 74-87, where the regular intervals of time are 3 seconds.

Example Clause 89: A system may include: one or more processors configured to: receive image data from a sensor; determine one or more light sources in the image data; determine one or more excluded light sources of the one or more light sources, where light sources in the image data not determined to be excluded light sources are remaining light sources in the image data; determine luminance information based on the remaining light sources in the image data; determine, based on the luminance information, that a sensor mode threshold has not been satisfied; and cause transmission of a control signal configured to cause the sensor to activate an infrared configuration based on the determining that the sensor mode threshold has not been satisfied.

Example Clause 90: The system of Example Clause 89, where the one or more processors, when the determining one or more excluded light sources of the one or more light sources, are configured to estimate a distance from each light source to the sensor.

Example Clause 91: The system of Example Clause 89 or Example Clause 90, where the one or more processors, when the determining one or more excluded light sources of the one or more light sources, are configured to estimate a brightness associated with each light source.

Example Clause 92: The system of any one of Example Clauses 89-91, where the one or more processors, when the determining luminance information based on the remaining light sources in the image data, are configured to make a determination of sufficient luminance based on an existence of at least one remaining light source in the image data.

Example Clause 93: The system of any one of Example Clauses 89-92, where the one or more processors, when the determining luminance information based on the remaining light sources in the image data, are configured to make a determination of insufficient luminance based on no remaining light source in the image data.

Example Clause 94: The system of any one of Example Clauses 89-93, where the one or more processors, when the determining one or more excluded light sources of the one or more light sources, are configured to ignore one or more portions of image data associated with the one or more excluded light sources.

Example Clause 95: The system of any one of Example Clauses 89-94, where the one or more processors, when the determining luminance information based on the remaining light sources in the image data, are configured to identify a recognized artifact or a feature of the recognized artifact in the image data.

Example Clause 96: The system of any one of Example Clauses 89-95, where the one or more processors, when the determining one or more excluded light sources of the one or more light sources, are configured to ignore one or more portions of image data associated with the one or more excluded light sources.

Example Clause 97: The system of any one of Example Clauses 89-96, where the one or more processors, when the determining luminance information based on the remaining light sources in the image data, are configured to identify a recognized artifact or a feature of the recognized artifact in a portion of the image data that is not ignored.

Example Clause 98: A system may include: one or more processors configured to: receive image data from a sensor; determine one or more light sources in the image data; determine one or more excluded light sources of the one or more light sources, where light sources in the image data not determined to be excluded light sources are remaining light sources in the image data; determine luminance information based on the remaining light sources in the image data; determine, based on the luminance information, that a sensor mode threshold has been satisfied; and cause transmission of a control signal configured to cause the sensor to activate a normal configuration based on the determining that the sensor mode threshold has been satisfied.

Example Clause 99: The system of Example Clause 98, where the one or more processors, when the determining one or more excluded light sources of the one or more light sources, are configured to estimate a distance from each light source to the sensor.

Example Clause 100: The system of Example Clause 98 or Example Clause 99, where the one or more processors, when the determining one or more excluded light sources of the one or more light sources, are configured to estimate a brightness associated with each light source.

Example Clause 101: The system of any one of Example Clauses 98-100, where the one or more processors, when the determining luminance information based on the remaining light sources in the image data, are configured to make a determination of sufficient luminance based on an existence of at least one remaining light source in the image data.

Example Clause 102: The system of any one of Example Clauses 98-101, where the one or more processors, when the determining luminance information based on the remaining light sources in the image data, are configured to make a determination of insufficient luminance based on no remaining light source in the image data.

Example Clause 103: The system of any one of Example Clauses 98-102, where the one or more processors, when the determining one or more excluded light sources of the one or more light sources, are configured to ignore one or more portions of image data associated with the one or more excluded light sources.

Example Clause 104: The system of any one of Example Clauses 98-103, where the one or more processors, when the determining luminance information based on the remaining light sources in the image data, are configured to identify a recognized artifact or a feature of the recognized artifact in the image data.

Example Clause 105: The system of any one of Example Clauses 98-104, where the one or more processors, when the determining one or more excluded light sources of the one or more light sources, are configured to ignore one or more portions of image data associated with the one or more excluded light sources.

Example Clause 106: The system of any one of Example Clauses 98-105, where the one or more processors, when the determining luminance information based on the remaining light sources in the image data, are configured to identify a recognized artifact or a feature of the recognized artifact in a portion of the image data that is not ignored.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving, by a computing device, image data indicative of one or more images captured by at least one sensor at a first premises;
receiving an indication about luminance information associated with the image data;
determining, based at least on the luminance information, whether a sensor mode threshold has been satisfied; and
causing transmission of a control signal to the at least one sensor based on the determining whether a sensor mode threshold has been satisfied.

2. The method of claim 1, wherein the determining whether a sensor mode threshold has been satisfied further comprises:
providing to a model a first dataset, wherein the first dataset comprises a plurality of images of the first premises in which a first artifact is visible, and wherein the first dataset comprises an indication of sufficient luminance; and
providing to the model a second dataset, wherein the second dataset comprises a plurality of images of the first premises in which the first artifact is not visible, and wherein the second dataset comprises an indication of insufficient luminance.

3. The method of claim 2, wherein the model indicates whether the sensor mode threshold has been satisfied based at least in part on visibility of the first artifact in the image data.

4. The method of claim 1, wherein the determining whether a sensor mode threshold has been satisfied further comprises:
providing to a model a first dataset, wherein the first dataset comprises a plurality of images satisfying a luminance threshold, and wherein the first dataset comprises an indication of sufficient luminance; and
providing to the model a second dataset, wherein the second dataset comprises a plurality of images below the luminance threshold, and wherein the second dataset comprises an indication of insufficient luminance.

5. The method of claim 4, wherein the model indicates whether the sensor mode threshold has been satisfied based at least in part on the image data.

6. The method of claim 1, wherein the indication about luminance information is based on an output of a computational model configured to recognize an artifact in an image.

7. The method of claim 6, wherein the computational model is configured to estimate a distance of the artifact to a sensor.

8. The method of claim 1, wherein the indication about luminance information is based on an output of a computational model configured to recognize a feature of an artifact in an image.

9. The method of claim 8, wherein the computational model is configured to estimate a distance of the feature to a sensor.

10. The method of claim 1, wherein the control signal is configured to cause the at least one sensor to activate an infrared configuration.

11. The method of claim 1, wherein the control signal is configured to cause the at least one sensor to activate an infrared configuration based on the determination that the sensor mode threshold has not been satisfied.

12. The method of claim 1, further comprising determining a foreign entity is present in the image data.

13. The method of claim 12, wherein the control signal is configured to oscillate between an infrared configuration and a normal configuration based on the determining a foreign entity is present in the image data.

14. The method of claim 1, wherein the control signal causes the at least one sensor to oscillate between an infrared configuration and a non-infrared configuration at regular intervals of time.

15. A method comprising:
receiving image data from a sensor;
determining one or more light sources in the image data;
determining one or more excluded light sources of the one or more light sources, wherein light sources in the image data not determined to be excluded light sources are remaining light sources in the image data;
determining luminance information based on the remaining light sources in the image data;
determining, based on the luminance information, whether a sensor mode threshold has been satisfied; and
causing transmission of a control signal to the sensor based on the determining whether a sensor mode threshold has been satisfied.

16. The method of claim 15, wherein the determining one or more excluded light sources of the one or more light sources further comprises estimating a distance from each light source to the sensor.

17. The method of claim 16, wherein the determining one or more excluded light sources of the one or more light sources further comprises estimating a brightness associated with each light source.

18. A method comprising:
receiving image data from a sensor;
determining one or more light sources in the image data;
determining one or more excluded light sources of the one or more light sources, wherein light sources in the image data not determined to be excluded light sources are remaining light sources in the image data;
determining luminance information based on the remaining light sources in the image data;
determining, based on the luminance information, that a sensor mode threshold has not been satisfied; and
causing transmission of a control signal configured to cause the sensor to activate an infrared configuration based on the determining that the sensor mode threshold has not been satisfied.

19. The method of claim 18, wherein the determining one or more excluded light sources of the one or more light sources further comprises estimating a distance from each light source to the sensor.

20. The method of claim 18, wherein the determining one or more excluded light sources of the one or more light sources further comprises estimating a brightness associated with each light source.
